(19) United States
(12) Patent Application Publication
(10) Pub. No.: US 2025/0210777 A1
(43) Pub. Date: Jun. 26, 2025

(54) BATTERY WITH CROSS-MEMBERS AND CORNER MEMBERS FOR AN ELECTRIC OR HYBRID VEHICLE, AND METHOD FOR ASSEMBLING SUCH A BATTERY

(71) Applicant: AUTOMOTIVE CELLS COMPANY SE, BRUGES (FR)

(72) Inventors: Pierre CHAUVEAU, BRUGES (FR); Alexandre MATHIEU, BORDEAUX (FR); Patrick BRIEN, PAREMPUYRE (FR); Dimitri MARATHE, VILLENAVE D'ORNON (FR)

(21) Appl. No.: 18/852,199

(22) PCT Filed: Mar. 29, 2023
(86) PCT No.: PCT/EP2023/058136

§ 371 Date: Sep. 27, 2024

(30) Foreign Application Priority Data
Mar. 31, 2022 (EP) 22305414.9

(51) Int. Cl. H01M 50/249; B60L 50/64; H01M 50/209; H01M 50/242; H01M 50/262; H01M 50/289; H01M 50/507

(52) U.S. Cl. CPC H01M 50/249; B60L 50/64; H01M 50/209; H01M 50/242; H01M 50/262; H01M 50/289; H01M 50/507; H01M 2220/20

(57) ABSTRACT

Disclosed is a battery for an electric or hybrid vehicle, comprising:
a casing defining a housing that extends in a longitudinal direction and a transverse direction, the housing having a first lateral edge,
a plurality of transverse cross-members,
a plurality of assemblies comprising electrochemical cells, the cross-members and the assemblies being arranged successively in the longitudinal direction in the housing,
a plurality of corner members for transmitting transverse forces between the cross-members and the housing, at least some of the corner members having a first portion that extends perpendicular to the transverse direction and is attached to a transverse end of at least some of the cross-members, and a second portion that extends transversely from the first portion and is attached to the first lateral edge; the assemblies, the first portion, and the first lateral edge at least partially define a longitudinally extending housing.

### CROSS-REFERENCE TO RELATED APPLICATIONS

This application is the U.S. national phase of International Application No. PCT/EP2023/058136 filed Mar. 29, 2023 which designated the U.S. and claims priority to EP patent application Ser. No. 22/305,414.9 filed Mar. 31, 2022, the entire contents of each of which are hereby incorporated by reference.

### TECHNICAL FIELD

The present invention relates to an electric battery.

The invention also relates to a cell assembly method for assembling the cells of such a battery.

### BACKGROUND

The invention is in particular applicable to the production of a battery, in particular for electric or hybrid vehicles. The term ‘battery’ is used to refer to a plurality of electrochemical cells that are electrically connected to one another. According to one particular example of a battery, the plurality of electrochemical cells is arranged in the form of one or more module(s), each module comprising a plurality of electrochemical cells that are electrically connected to one another and mechanically assembled with each other by means of an assembly system, such as assembly plates. An electrochemical cell comprises, in particular, a stacked set of positive electrodes connected to each other, and a stacked set of negative electrodes connected to each other, which are separated by a separator, known as a ‘stack’. The positive electrodes connected to each other form a positive terminal, and the negative electrodes connected to each other form a negative terminal.

The battery generally comprises a casing which contributes to the protection of its internal component elements, in particular the cells and connectors. In order to enable the battery to withstand shocks, for example lateral shocks, to which the vehicle may be subjected, the casing generally includes fixed cross-members extending between two lateral edges of the casing positioned opposite each other in a transverse direction, for example that of the vehicle. The casing thus predefines the compartments within which the modules are then placed.

However, the electrical connections between the modules generally straddle the cross-members. The foregoing has the effect of leaving a space above the electrochemical cells in the casing, on the side opposite the bottom of the casing. This has a negative impact on the compactness of the battery and the energy density thereof, for example expressed in W·h/L (watt·hour per litre).

### SUMMARY OF THE INVENTION

One objective of the invention is therefore to provide a battery that offers optimum energy density, while at the same time being sufficiently resistant to any lateral shocks to which the vehicle may be subjected.

To this end, the invention relates to a battery for an electric or hybrid vehicle, the battery comprising:
a casing defining a housing that extends in a longitudinal direction and in a transverse direction perpendicular to the longitudinal direction, the casing having a first lateral edge and a second lateral edge that are disposed transversely opposite each other,
a plurality of cross-members extending in the transverse direction, each of the cross-members comprising two transverse ends opposite each other,
a plurality of assemblies, each of the assemblies comprising electrochemical cells that extend successively in the transverse direction and are integrally attached to each other, the cross-members and the assemblies being arranged successively in the longitudinal direction in the housing, and
a plurality of corner members that are adapted for transmitting transverse forces between the cross-members and the casing, at least some of the corner members having a first portion that extends perpendicular to the transverse direction and is attached to one of the transverse ends of at least some of the cross-members; and a second portion that extends transversely from the first portion and is attached to the first lateral edge; the assemblies, the first portion, and the first lateral edge at least partially define a longitudinally extending first housing.

According to some particular embodiments, the battery includes one or more of the following features, taken into consideration in isolation or according to any technically feasible combination:
at least some of the corner members have a first portion that extends perpendicular to the transverse direction and is attached to the other of the transverse ends of at least some of the cross-members; and a second portion that extends transversely from the first portion and is attached to the second lateral edge; the assemblies, the first portion, and the second lateral edge at least partially defining a longitudinally extending second housing that is adapted for casing one or more electrical connectors of the battery;
the second portion defines at least one attachment hole that is adapted for receiving a screw of the battery, the second portion being in planar contact with, and attached by the screw to, a shoulder or longitudinal rail of the casing;
the casing comprises a bottom, the battery further comprising at least one cover that extends in the longitudinal direction and is disposed transversely between the first lateral edge and the first portion of at least some of the corner members, the cover at least partially delimiting the first housing, the cover being situated on the other side of the second portion of each of the said some of the corner members relative to the bottom in a third direction that is perpendicular to the longitudinal direction and the transverse direction.
the cover exhibits a cross-section perpendicular to the longitudinal direction in the shape of an “L”;
the corner members have a third portion that extends transversely from the first portion on the same side as the second portion, the third portion being located on the other side of the second portion relative to the bottom in the third direction, the cover abutting the second portion and the third portion in the third direction;
the cross-members and the assemblies are arranged against one another in the longitudinal direction, such as to ensure that there is no mechanical play between the cross-members and the assemblies;
at least some of the cross-members have, perpendicularly to the transverse direction, a “T”- or “H”-shaped cross-section;
each of the assemblies further comprises: two lateral plates that extend perpendicularly to the longitudinal direction and are located longitudinally on either side of the electrochemical cells; and at least two layers of adhesive or two layers of a flexible material located longitudinally between the electrochemical cells and the two lateral plates respectively; and
each of the assemblies further comprises two extreme end positioned plates that extend perpendicularly to the transverse direction, and transversely on either side of the electrochemical cells, with one of the two extreme end positioned plates of each of the assemblies being located transversely on the other side of the first portion of one of the corner members relative to the first lateral edge of the casing.

The object of the invention also relates to a battery assembly method for assembling a battery as described above, the method comprising:
arranging of the cross-members and the assemblies in a longitudinal mounting direction in order to obtain an arranged system wherein the cross-members extend in a transverse mounting direction perpendicular to the longitudinal mounting direction, with the electrochemical cells of each of the assemblies extending successively in the transverse mounting direction, the cross-members and the assemblies being disposed successively in the clamping direction; and
attaching onto the casing of the cross-members and/or the assemblies in order to obtain an attached system, the attached system being located in the housing and oriented relative to the casing such as to ensure that the longitudinal mounting direction is parallel to the longitudinal direction defined by the battery in the assembled state, and that the transverse mounting direction is parallel to the transverse direction defined by the battery in the assembled state, the second portion of at least some of the corner members being attached to the first lateral edge of the casing.

According to some particular embodiments, the method comprises one or more of the following features, taken into consideration individually or in accordance with all technically feasible combinations:
the arranging of the cross-members and the assemblies in the longitudinal mounting direction includes the clamping of the cross-members and the assemblies against each other in the longitudinal mounting direction;
the clamping of the cross-members and the assemblies against each other is executed within the housing, the longitudinal mounting direction being parallel to the longitudinal direction and the transverse mounting direction being parallel to the transverse direction during the clamping; and
the clamping of the cross-members and the assemblies against each other is executed outside of the housing, the clamped system comprising tie-rods that extend in the longitudinal mounting direction and clamping members, with the cross-members and the assemblies being slipped onto the tie-rods, and the clamping members being disposed on the tie-rods so as to compress the assemblies and cross-members in the longitudinal mounting direction; and the attachment onto the casing of the clamped system comprises of the movement as a block of the clamped system into the housing.

### BRIEF DESCRIPTION OF THE DRAWINGS

The invention will be better understood upon reading the description that follows, provided solely by way of example and made with reference to the appended drawings, in which:

FIG. 1 is a perspective view of a battery according to the invention;

FIG. 2 is a perspective view of the battery represented in FIG. 1, with some of the assemblies having been omitted, and some electrochemical cells and connectors having been omitted for one of the assemblies represented;

FIG. 3 is a perspective view of one of the assemblies of the battery represented in FIG. 1;

FIG. 4 depicts the battery represented in FIG. 1, in cross sectional view along a plane perpendicular to the transverse direction;

FIG. 5 is a perspective view of a portion of the battery represented in FIG. 1, the casing being omitted in order to better show the corner members; and

FIG. 6 is a cross-sectional view of a corner member of the battery represented in FIG. 1, the cross section being along a plane perpendicular to the longitudinal direction.

### DETAILED DESCRIPTION OF PREFERRED EMBODIMENTS

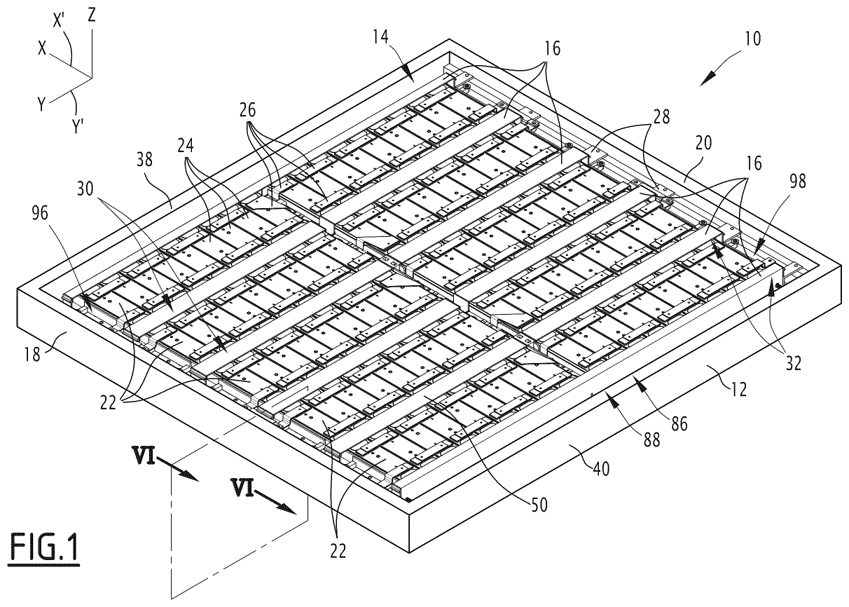

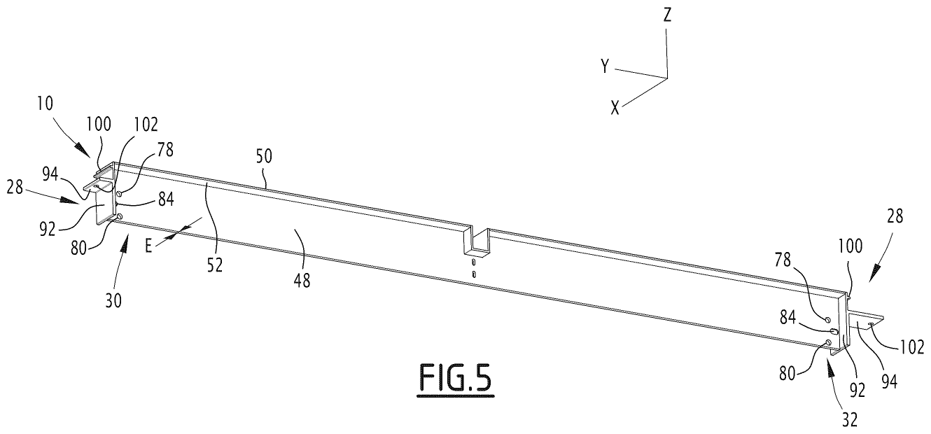

With reference to FIGS. 1 to 6, they are used to describe a battery 10 according to the invention.

The battery 10 is for example designed to be installed in an electric or hybrid motor vehicle (not represented).

As can be seen in FIG. 1, the battery 10 comprises a defining a housing 14 that extends in a longitudinal direction X, which is for example the direction of forward travel of the vehicle; and in a transverse direction Y perpendicular to the longitudinal direction and which is for example the transverse direction of the vehicle.

Optionally, the battery 10 comprises a cover, not represented, for closing the casing 12.

By way of variant, the battery 10 is without a cover and advantageously mounted in direct connection with the floor of the vehicle. For example, the battery 10 is bonded to a lower surface of the floor.

Also defined is a third direction Z perpendicular to the longitudinal direction X and to the transverse direction Y, and which is intended, for example, to be substantially vertical when the vehicle is located on a horizontal surface (not represented).

The battery 10 additionally comprises a plurality of cross-members 16 that extend in the transverse direction Y between a first lateral edge 18 and a second lateral edge 20 of the casing 12 that are transversely opposite each other. The battery 10 also comprises a plurality of assemblies 22, with each of the assemblies comprising electrochemical cells 24 that extend successively in the transverse direction Y while also being integrally joined to each other mechanically.

The battery 10 also comprises electrical connectors 26 that are disposed: within the assemblies, in order to connect the electrochemical cells 24 to one another; and between the assemblies 22, in order to connect the assemblies to one another.

The battery also comprises corner members 28 that are attached, for example welded, onto two transverse ends 30, 32 of each of the cross-members 16, and attached onto the casing.

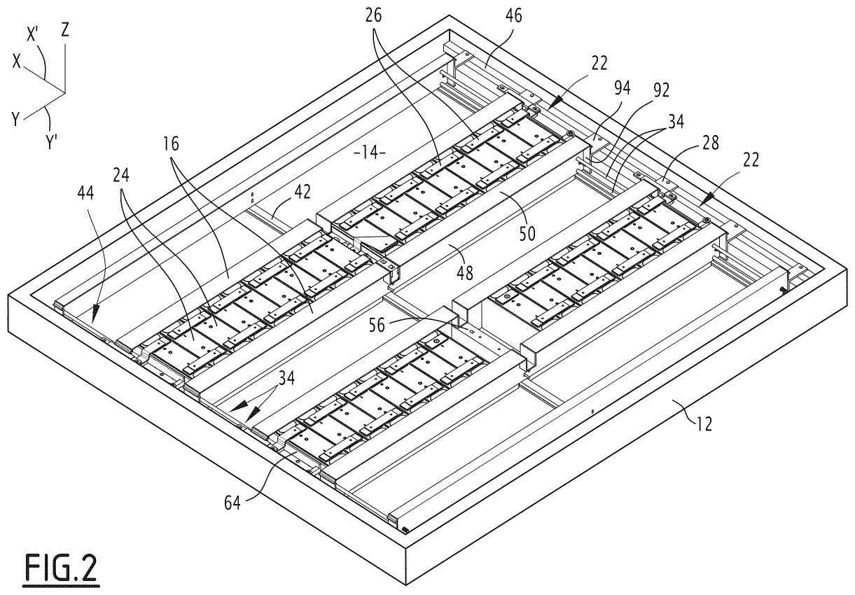

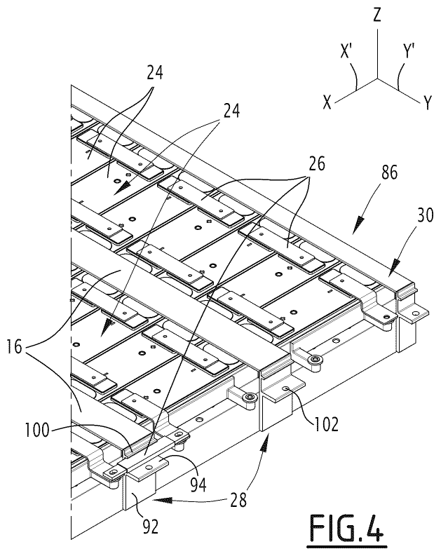

According to one particular embodiment, the battery 10 also comprises longitudinal tie rods 34 (FIGS. 2 and 4), which play a role in the assembly of the battery as will be explained below.

The battery 10 also includes attachment members (not represented), such as screws, for attaching the assemblies 22 and the cross-members 16 to the casing 12.

In the example, the battery 10 comprises five assemblies 22 and six cross-members 16. Four of the six cross-members 16 are interposed longitudinally between the assemblies 22, and two cross-members are referred to longitudinally as ‘end’ cross-members, as they run respectively alongside only one of the assemblies.

According to other embodiments not represented, the number of assemblies 22 is less than five or more than five, and the number of cross-members 16 is less than six or more than six.

According to one variant (not represented), each of the cross-members 16 is located longitudinally between two of the assemblies 22. The number of cross-members 16 is thus then equal to the number of assemblies 22 minus one.

The casing 12 has, for example, a parallelepiped shaped form, which is advantageously planar in the third direction Z, as the battery is, for example, intended to be integrated into the lower part of the vehicle, for example under a passenger compartment.

In addition to the first lateral edge 18 and the second lateral edge 20, the casing 12 comprises a bottom 36, and a third lateral edge 38, and a fourth lateral edge 40 that are opposite each other in the longitudinal direction X.

The casing 12 defines, for example, longitudinal rails 42, 44, 46 (FIG. 2) that are designed to facilitate guiding of the assemblies 22 and the cross-members 16 during assembly of the battery 10, and to serve as attachment supports for the assemblies and cross-members.

The rail 42, for example, projects out from the bottom 36.

The rails 44, 46 extend respectively over the first lateral edge 18 and over the second lateral edge 20.

The cross-members 16 and the assemblies 22 are arranged in the housing 14 successively in the longitudinal direction X, for example in an alternating manner. The cross-members 16 and the assemblies 22 are advantageously positioned against each other in the longitudinal direction X, such as to ensure that there is no mechanical play between the cross-members 16 and the assemblies 22, with the assemblies and cross-members being attached to the casing 12. Consequently, the cross-members 16 are thus more resistant to buckling in the event of a lateral shock impact (in the transverse direction Y) on the vehicle, as they are held in place by the assemblies 22.

The cross-members are fitted onto the casing 12 when the battery 10 is assembled. As a result, the casing 12 and the cross-members 16 do not predefine the compartments within which the assemblies 22 are to be placed.

In the example, the cross-members 16 and the assemblies 22 form a simple alternating arrangement (one assembly 22 followed by one cross-member 16 followed by one assembly 22, etc).

According to variants not represented, the alternating arrangement may be more complex (for example two assemblies 22 followed by one cross-member 16 followed by two assemblies 22 . . . etc).

According to yet more variants, the alternating arrangement may be irregular (for example one assembly 22 followed by one cross-member 16 followed by two assemblies 22 followed by one cross-member 16 . . . ).

More generally, the cross-members 16 may separate one or two assemblies 22, or even more, or be in an extreme end position (i.e. with one assembly 22 on one side only).

By way of a variant (not represented), the cross-members 16 and the assemblies 22 are not positioned against each other in the longitudinal direction X, for example in order to maintain mechanical play between the assemblies 22 and the cross-members 16 when assembling the battery 10.

At least some of the cross-members 16, in the example those which are not positioned at the extreme ends, exhibit, perpendicularly to the transverse direction Y, a ‘T’-shaped cross-section (FIG. 4).

According to variants that are not represented, the cross-section is in the shape of an ‘H’, a ‘C’, a ‘U’, or forms a rectangle (in which case the cross-member is tubular).

In the example, the extreme end positioned cross-members 16 have a cross-section that is different from that of the non-extreme end positioned cross-members, for example a ‘C’ shaped cross-section.

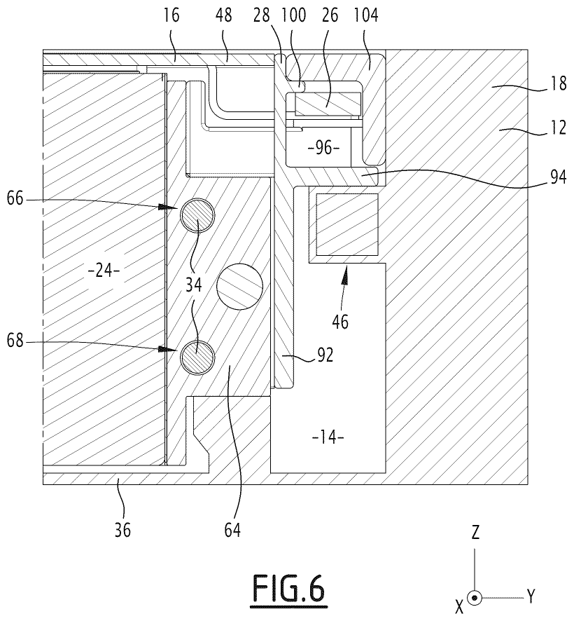

As can be seen in FIGS. 4 and 6, the cross-members 16 comprise, for example, a first portion 48 that extends perpendicularly to the longitudinal direction X. In the example, all the cross-members 16 additionally comprise a second portion 50 that is attached to the first portion on the side opposite the bottom 36.

The first portion 48 of the non-extreme end positioned cross-members 16 is located longitudinally between two of the assemblies 22. The first portion 48 of all the cross-members 16 advantageously exhibits a thickness 48 of material in the longitudinal direction X measuring less than 20 mm, preferably less than 10 mm. Thus, two longitudinally consecutive assemblies 22 are separated by less than 20 mm, advantageously by less than 10 mm.

The second portion 50 extends, for example, perpendicularly to the third direction Z. The second portion 50 is, for example, integrally formed in one piece with the first portion 48.

The second portion 50 of the non-extreme end cross-members 16 abuts two of the assemblies 22 in the third direction Z by means of two layers 52 of flexible material, for example a foam.

By way of a variant, the second portion 50 directly abuts the assemblies 22.

The second portion 50 of the extreme end positioned cross-members 16 abuts only one of the assemblies 22 either by means of a layer 54 of flexible material or, as an alternative, directly.

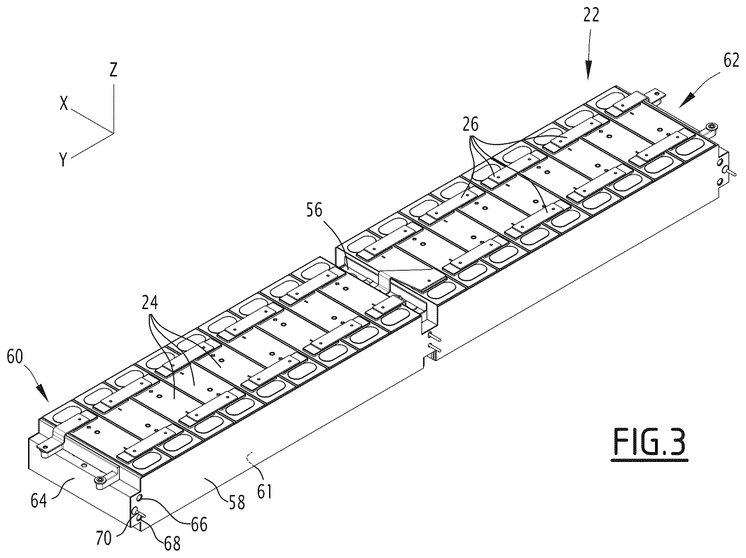

In the example, each of the assemblies 22 comprises a central plate 56 (FIGS. 2 and 3) that extends perpendicularly to the transverse direction Y, with the electrochemical cells 24 being situated transversely on either side of the central plate.

Each of the assemblies 22 comprises, for example: two lateral plates 58, 60 (FIG. 3) that extend perpendicularly to the longitudinal direction X and are located longitudinally on either side of the electrochemical cells 24; and at least two layers of adhesive 61 or two layers of a flexible material (not shown) located longitudinally between the electrochemical cells 24 and the two lateral plates 58, 60 respectively.

Each of the assemblies 22 comprises, for example, two extreme end positioned plates 62, 64 that extend perpendicularly to the transverse direction Y, transversely on either side of the electrochemical cells 24.

The central plates 56 are advantageously capable of withstanding the longitudinal forces liable to be applied to them by the cross-members 16, and therefore contribute to reducing the risk of the cross-members buckling in the event of a lateral shock impact to the vehicle.

Each of the two extreme end plates 62, 64 advantageously defines two longitudinal through cavities 66, 68.

The tie rods 34 extend into the cavities 66, 68 defined by the extreme end positioned plates 62, 64, and pass through the holes 78, 80 defined by the transverse ends 30, 32 of the cross-members 16. In the example, the tie rods 34 also pass through the two lateral plates 58, 60 of each of the assemblies 22.

The corner members 28 are adapted for transmitting transverse forces between the cross-members 16 and the casing 12.

The transverse ends 30, 32 of each of the cross-members are transversely opposite each other. The transverse ends 30 are all located transversely on the same given side relative to the transverse ends 32.

In the example, the corner members 28 are attached to the two transverse ends 30, 32 of each of the cross-members 16.

According to variants not represented, the corner members 28 are attached only to the transverse end 30 of each of the cross-members 16, or even of only some of the cross-members 16.

In the example, some of the corner members 28 comprise a first portion 92 that extends perpendicularly to the transverse direction Y and is attached, for example welded, to the transverse end 30 of the cross-members 16; and a second portion 94 that extends transversely from the first portion 92 and is attached to the first lateral edge 18. The assemblies 22, the first portion 92 of these corner members 28, and the first lateral edge 18 at least partially define a longitudinally extending first housing 96 that is intended, for example, to house one or more of the electrical connectors 26 of the battery.

In the other corner members 28, the first portion 92 extends perpendicularly to the transverse direction Y and is attached, for example welded, to the transverse end 32 of the cross-members 16. For these other corner members 28, the second portion 94 extends transversely from the first portion 92 and is attached to the second lateral edge 20. The assemblies 22, the first portion 92 of these other corner members 28, and the second lateral edge 20 at least partially define a longitudinally extending second housing 98 that is capable of housing one or more of the electrical connectors 26 of the battery 10, in particular the connecting bars that connect some of the assemblies 22 to each other.

The corner members 28 advantageously comprise a third portion 100 that extends transversely from the first portion 92 on the same side as the second portion 94, the third portion 100 being located on the other side of the second portion relative to the bottom 36 in the third direction Z.

The second portion 94 defines at least one attachment hole 102 that is adapted for receiving a screw (not represented) of the battery 10, the second portion 92 being in planar contact with, and attached by the screw to, the longitudinal rail 44, 46 of the casing 12.

Advantageously, the battery 10 also comprises at least one cover 104 (FIG. 6) that extends in the longitudinal direction X and is disposed transversely between the first lateral edge 18 and the first portion 92 of at least some of the corner members 28.

The cover 104 at least partially delimits the first housing 96. The cover 104 is located on the other side of the second portion 94 of each of these corner members 28 relative to the bottom 36 in the third direction Z.

Advantageously, the battery 10 comprises a second cover (not represented) which is analogous to the cover 104. This second cover extends in the longitudinal direction X and is disposed transversely between the second lateral edge 20 and the first portion 92 of the other corner members 28.

The cover 104 exhibits a cross-section perpendicular to the longitudinal direction X, for example in the shape of an ‘L’.

The cover 104 abuts for example, the second portion 92 and the third portion 100 in the third direction Z.

In the example, at least the corner members 28 and the extreme end positioned plates 62, 64 are screwed onto the casing 12.

A first assembly method for assembling the battery 10 will be described hereinafter.

The first method comprises an arrangement step for arranging the cross-members 16 and the assemblies 22 in a longitudinal mounting direction X′ in order to obtain an arranged system 86; and an attachment step for attaching the cross-members 16 and/or the assemblies 22 to the casing in order to obtain an attached system 88.

In the arranged system 86, the cross-members 16 extend in a transverse mounting direction Y′ perpendicular to the clamping direction X′. The electrochemical cells 24 of each of the assemblies 22 extend successively in the transverse mounting direction Y′. The cross-members 16 and assemblies 22 are disposed successively in the clamping direction X′, for example in an alternating manner.

Advantageously, the arranging of the cross-members 16 and assemblies 22 includes the clamping of the cross-members 16 and assemblies 22 against each other in the longitudinal mounting direction X′.

The attached system 88 is located in the housing 14 and oriented relative to the casing 12 in a manner such that the clamping direction X′ is parallel to the longitudinal direction X defined by the battery 10 in the assembled state, and the transverse mounting direction Y′ is parallel to the transverse direction Y defined by the battery 10 in the assembled state. The cross-members 16 of the attached system 88 extend between the first lateral edge 18 and the second lateral edge 20 of the casing 12. The second portion 94 of some of the corner members 28 is attached to the first lateral edge 18 of the casing 12, and the second portion 94 of the other corner members 28 is attached to the second lateral edge 20.

In the first method, the arranging of the cross-members 16 and the assemblies 22 is advantageously executed within the housing 14. The longitudinal mounting direction X′ is parallel to the longitudinal direction X, and the transverse mounting direction Y′ is parallel to the transverse direction Y from the assembly step onwards.

Advantageously, the rails 44, 46 facilitate the positioning and possible clamping, as appropriate, of the assemblies 22 and cross-members 16.

Advantageously, the corner members 28 slide over the rails 44, 46 prior to being attached.

The extreme end positioned plates 62, 64 of each of the assemblies 22, and the corner members 28 are, for example, screwed onto the casing 12. Thus, the cross-members 16 are advantageously attached by means of the corner members 28.

According to particular embodiments, other elements of the assemblies 22, or portions of the cross-members 16, are attached to the casing 12.

A second assembly method for assembling the battery 10 will hereinafter be described. The second method is analogous to the first method, and comprises an arrangement step and an attachment step. Only the differences between the two will be described in detail below.

In the second method, the arranging step does not take place within the housing 14, but outside the latter. The arranging, with eventual clamping as appropriate, is, for example, completely executed prior to attachment.

During the arranging step, the longitudinal mounting direction X′ and the transverse mounting direction Y′ are therefore not necessarily parallel respectively to the longitudinal direction X and the transverse direction Y, which will be subsequently defined by the battery 10 in the assembled state in the housing 14. To put it more simply, the arranged system 86 is not located within the housing 14 and may therefore have any orientation relative to the casing 12.

The arranged system 86 advantageously comprises tie rods 34, that extend in the longitudinal mounting direction X′, as well as clamping members 90.

In order to implement the arrangement, the cross-members 16 and the assemblies 22 are, for example, slipped onto the tie-rods 34.

In order to effect the eventual clamping, as appropriate, the clamping members 90 are disposed on the tie rods 34 so as to compress the assemblies 22 and the cross-members 16 in the longitudinal mounting direction X′. For example, the clamping members 90 are screwed onto one end of each of the tie rods 34.

In order to effect the attachment onto the casing 12, the arranged system 86 is moved as a block into the housing 14. Subsequently, the arranged system 86 is attached onto the casing 12, for example by means of screws.

The second method offers the advantage that the arranging step, with possible clamping as appropriate, is performed without being hindered or constrained by the presence of the casing 12. In the example, it requires tie rods 34, that are additional parts, which however facilitate the arranging, while ensuring optimal clamping, with good transverse homogeneity.

Thanks to the characteristic features described above, the battery 10 offers enhanced energy density, while at the same time being sufficiently resistant to any lateral shock impacts to which the vehicle may be subjected.

In effect, the first housing 96 defined by the casing 12, the assemblies 22, the corner members 28 and the possible cover 104, for example, serves to enable the passing of some of the electrical connectors 26 not above the assemblies 22 (on the side opposite the base 36 of the casing 12), but alongside them, with a much smaller loss of energy storage volume. The same is true for any potential second housing 98.

In addition, the corner members 28 serve to enable good transmission of transverse forces between the cross-members 16 and the casing 12, and to facilitate attaching onto the casing 12 of the cross-members 16.

In addition, according to one preferred embodiment, the assemblies 22 are not inserted into the compartments defined by the cross-members 16 that are pre-attached to the casing 12. The cross-members 16 and the assemblies 22 may then be clamped together against each other with no clearance. Whether the clamping takes place within the casing 12 (first method) or outside of the casing 12 (second method), the attaching of the cross-members 16 does not prevent this proper clamping. As a result thereof, the distance between two longitudinally consecutive assemblies 22 is reduced. This in turn leads to an increase in the energy density of the battery 10.

In addition, as a result of the clamping, the assemblies 22 limit the possibility of the cross-members 16 succumbing to buckling in the event of lateral shock impact, by preventing the cross-members 16 from bending in a plane perpendicular to the third direction Z. In this way, it is possible to operationally deploy cross-members 16 wherein the first portion 48, located between two consecutive assemblies 22, is thinner, all other things being equal. This again provides the means to increase the energy density.

Where applicable and present the central plates 56 of the assemblies 22 advantageously reinforce this effect.

1. A battery for an electric or hybrid vehicle, the battery comprising:
a casing defining a housing that extends in a longitudinal direction and in a transverse direction perpendicular to the longitudinal direction, the casing having a first lateral edge and a second lateral edge that are disposed transversely opposite each other,
a plurality of cross-members extending in the transverse direction, each of the cross-members comprising two transverse ends opposite each other,
a plurality of assemblies, each of the assemblies comprising electrochemical cells that extend successively in the transverse direction and are integrally attached to each other, the cross-members and the assemblies being arranged successively in the longitudinal direction in the housing, and
a plurality of corner members that are adapted for transmitting transverse forces between the cross-members and the casing, at least some of the corner members having a first portion that extends perpendicular to the transverse direction and is attached to one of the transverse ends of at least some of the cross-members; and a second portion that extends transversely from the first portion and is attached to the first lateral edge, the assemblies, the first portion, and the first lateral edge at least partially define a longitudinally extending first housing.

2. The battery according to claim 1, wherein at least some of the corner members have a first portion that extends perpendicular to the transverse direction and is attached to the other of the transverse ends of at least some of the cross-members; and a second portion that extends transversely from the first portion and is attached to the second lateral edge, the assemblies, the first portion, and the second lateral edge at least partially defining a longitudinally extending second housing that is adapted for housing one or more electrical connectors of the battery.

3. The battery according to claim 1, wherein the second portion defines at least one attachment hole that is adapted for receiving a screw of the battery, the second portion being in planar contact with, and attached by the screw to, a shoulder or longitudinal rail of the casing.

4. The battery according to claim 1, wherein the casing comprises a bottom, the battery further comprising at least one cover that extends in the longitudinal direction and is disposed transversely between the first lateral edge and the first portion of at least some of the corner members, the cover at least partially delimiting the first housing, the cover being situated on the other side of the second portion of each of the said some of the corner members relative to the bottom in a third direction that is perpendicular to the longitudinal direction and the transverse direction.

5. The battery according to claim 4, wherein the cover exhibits a cross-section perpendicular to the longitudinal direction in the shape of an “L”.

6. The battery according to claim 4, wherein the corner members have a third portion that extends transversely from the first portion on the same side as the second portion, the third portion being located on the other side of the second portion relative to the bottom in the third direction, the cover abutting the second portion and the third portion in the third direction.

7. The battery according to claim 1, wherein the cross-members and the assemblies are arranged against one another in the longitudinal direction, such as to ensure that there is no mechanical play between the cross-members and the assemblies.

8. The battery according to claim 1, wherein at least some of the cross-members have, perpendicularly to the transverse direction, a “T”- or “H”-shaped cross-section.

9. The battery according to claim 1, wherein each of the assemblies further comprises:
two lateral plates that extend perpendicularly to the longitudinal direction and are located longitudinally on either side of the electrochemical cells; and
at least two layers of adhesive or two layers of a flexible material located longitudinally between the electrochemical cells and the two lateral plates respectively.

10. The battery according to claim 1, wherein each of the assemblies further comprises two extreme end positioned plates that extend perpendicularly to the transverse direction, and transversely on either side of the electrochemical cells, with one of the two extreme end positioned plates of each of the assemblies being located transversely on the other side of the first portion of one of the corner members relative to the first edge of the casing.

11. The battery assembly method for assembling a battery as described in claim 1, the method comprising:
arranging of the cross-members and the assemblies in a longitudinal mounting direction in order to obtain an arranged system wherein the cross-members extend in a transverse mounting direction perpendicular to the longitudinal mounting direction, with the electrochemical cells of each of the assemblies extending successively in the transverse mounting direction, the cross-members and the assemblies being disposed successively in the clamping direction; and
attaching onto the casing of the cross-members and/or the assemblies in order to obtain an attached system, the attached system being located in the housing and oriented relative to the casing such as to ensure that the longitudinal mounting direction is parallel to the longitudinal direction defined by the battery in the assembled state, and that the transverse mounting direction is parallel to the transverse direction defined by the battery in the assembled state, the second portion of at least some of the corner members being attached to the first lateral edge of the casing.

12. A method according to claim 11, wherein the arranging of the cross-members and the assemblies in the longitudinal mounting direction includes the clamping of the cross-members and the assemblies against each other in the longitudinal mounting direction.

13. The method according to claim 12, wherein the clamping of the cross-members and the assemblies against each other is executed within the housing, the longitudinal mounting direction being parallel to the longitudinal direction and the transverse mounting direction being parallel to the transverse direction during the clamping.

14. The method according to claim 12, wherein:
the clamping of the cross-members and the assemblies against each other is executed outside of the housing, the clamped system comprising tie-rods that extend in the longitudinal mounting direction and clamping members, with the cross-members and the assemblies being slipped onto the tie-rods, and the clamping members being disposed on the tie-rods so as to compress the assemblies and the cross-members in the longitudinal mounting direction, and
the attachment onto the casing of the clamped system comprises of the movement as a block of the clamped system into the housing.
